(19) United States
(12) Patent Application Publication
(10) Pub. No.: US 2002/0070079 A1
(43) Pub. Date: Jun. 13, 2002

(54) Portable segmented ladder chute

(76) Inventor: Richard A. Rosenwinkel, Glen Ellyn, IL (US)

Correspondence Address: FACTOR & PARTNERS, LLC, 1327 W. WASHINGTON BLVD., SUITE 5G/H, CHICAGO, IL, 60607, US

(21) Appl. No.: 09/905,636

(22) Filed: Jul. 13, 2001

Related U.S. Application Data
(60) Provisional application No. 60/218,444, filed on Jul. 14, 2000.

(51) Int. Cl. E06C 5/32

(52) U.S. Cl. 182/49; 182/129

(57) ABSTRACT

A ladder chute comprises a plurality of chute segments. Each of the plurality of chute segments including a panel having a top surface and a bottom surface and means for attachment to a rung of a ladder. The attachment means extending from the panel and below the bottom surface of the panel to facilitate attachment to a ladder. The invention further includes a method of erection and operation.

### CROSS-REFERENCE TO RELATED APPLICATION

This applications claims the benefit of U.S. Provisional Patent Application 60/218,444 filed Jul. 14, 2000 entitled “Portable Segmented Ladder Chute”.

### BACKGROUND OF THE INVENTION

1. Field of the Invention

The present invention relates in general to a chute, and more particularly, to a chute comprised of individual chute segments which removably attach to the rungs of a ladder to form a single continuous chute suitable for use in residential construction projects.

2. Background Art

When renovating the interior of a commercial building debris material must be discarded. In order to discard the material, typically a dumpster or bin is placed outside of the building. A chute is then secured from a window in or near the area being renovated to a dumpster or bin down below. Workers then place discarded material into the chute which directs the material into the bin for later disposal.

While this setup is convenient for large commercial buildings, it is impractical for residential homes renovation projects. Such setups are costly and constructed for large scale construction projects. They are also difficult to piece together. What is needed is a simple and easy to use chute system for use in residential construction and/or renovation sites.

It is therefore an object of the present invention to provide a easy to use chute system to direct discard materials in a predetermined direction.

It is yet another object of the present invention to provide a cost effective method of directing discard material into a dumpster or bin for later disposal.

It is further an object of the present invention to provide a portable chute system which can be easily assembled and disassembled for storage.

These and other objects will become evident upon review of the appended specification, claims and drawings.

### SUMMARY OF THE INVENTION

The invention comprises a ladder chute which includes a plurality of chute segments. Each of the plurality of chute segments includes a panel having a top surface and a bottom surface and means for attachment to a rung of a ladder. The attachment means extending from the panel and below the bottom surface of the panel to facilitate attachment to a ladder.

In one embodiment, at least one of the plurality of chute segments further comprises sidewalls extending from a proximal end to the distal end of the panel. The sidewalls cooperate with the panel to define a channel. In one such embodiment, at least one of the plurality of chute segments further comprises a top panel associated with at least one of the sidewalls. The top panel cooperates with the panel and the sidewalls to define a tunnel. In another such embodiment the panel is narrower at a distal end thereof as compared to the proximal end thereof, to, in turn, facilitate nesting of the plurality of chute segments relative to each other.

In another embodiment, the attachment means comprises at least one hook associated with the bottom surface of the panel to faciliate attachment to a ladder. In one such embodiment, the attachment means is positioned proximate a proximal end of the panel.

In a preferred embodiment, the top panel comprises an upwardly concave shape. In one embodiment, the upwardly concave shape comprises one of the group consisting of: a v-shaped configuration and a semicircular configuration.

In another embodiment, at least one of the plurality of chute segments further comprises a top panel, to, in turn, define a tubular configuration. In yet another embodiment, at least one of the chute segments further includes at least one divider.

In yet another embodiment, the attachment means comprises a member configured to interface with at least a portion of an interior region of an at least partially hollow ladder rung.

Preferably, plurality of segmented chutes is greater than five segmented chutes.

In a preferred embodiment, the plurality of segmented chutes includes at least two segmented chutes of different length.

In another embodiment, the length of the chute segment is adjustable.

In another aspect of the invention, the invention comprises a ladder chute. The ladder chute comprises a plurality of chute segments. Each of the plurality of chute segments including a panel having a top surface and a bottom surface and means for attachment to a rung of a ladder. The attachment means extends from the panel and above the upper surface of the panel to facilitate attachment to a ladder substantially without affecting the use thereof by a user.

In one preferred embodiment, the attachment means comprises at least one hook positioned at either side of the panel. At least one of the hooks is configured so as to include means for precluding rotative movement of the panel relative to a ladder rung to which the panel is associated.

The invention further comprises a method of erecting a ladder chute comprising the steps of providing a plurality of chute segments, providing a ladder having a plurality of rungs, attaching a first chute segment to a first rung, attaching at least one subsequent chute segment a second rung, and overlaying at least a portion of the subsequent chute segment over the first chute segment.

In one embodiment, the method further comprises the step of associating a container with at least one chute segment, to in turn, facilitate the slidable movement of debris from the plurality of chute segments into the container.

### BRIEF DESCRIPTION OF THE DRAWINGS

A detailed description will be provided below with reference to drawings in which:

FIG. 1 of the drawings is an elevational view of the ladder chute system of the present invention;

FIG. 2 of the drawings is a bottom plan view of a chute segment of the present invention;

FIG. 3 of the drawings is a perspective view of an embodiment of the present invention;

FIG. 4 of the drawings is a perspective view of a third embodiment of the present invention;

FIG. 5 of the drawings is an another elevational view of the ladder chute system of the present invention;

FIG. 6 of the drawings is a perspective view of a chute segment of the present invention;

FIG. 7 of the drawings is a side elevational view of an embodiment of the present invention in operation;

FIG. 8 of the drawings is a side elevational view of an embodiment of the present invention;

FIG. 9 of the drawings is a front plan view of an embodiment of the present invention;

FIG. 10 of the drawings is a side elevational view of an embodiment of the present invention; and

FIG. 11 of the drawings is a perspective view of an embodiment of the present invention.

### DETAILED DESCRIPTION OF THE DRAWINGS

While this invention is susceptible of embodiment in many different forms, there is shown in the drawings and will herein be described in detail several specific embodiments with the understanding that the present disclosure is to be considered as an exemplification of the principles of the invention and is not intended to limit the invention to the embodiments illustrated.

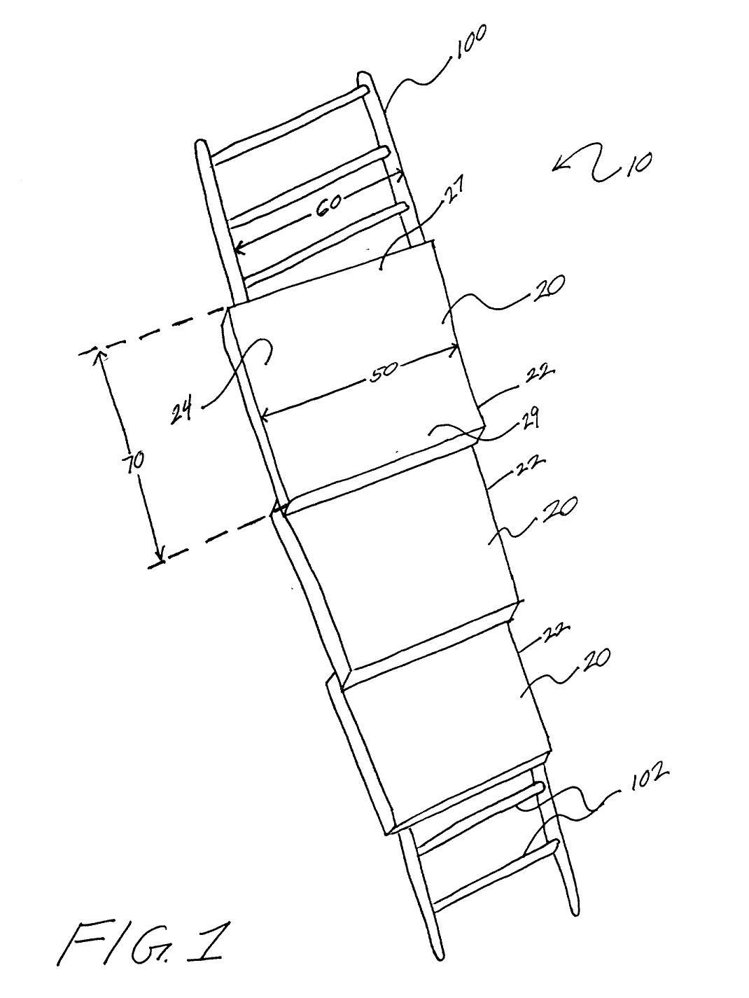

Turning now to the drawings, and more particularly to FIG. 1, a ladder chute is shown generally at 10. Ladder chute 10 is comprised of individual chute segments 20 which are removably attachable to ladder 100 and fit together to form a single chute of variable length. Ladder 100 is a conventional straight or extension ladder which is currently available on the market.

Each chute segment 20 is comprised of panel 22 having a top surface 24, bottom surface 26, proximal end portion 27 and distal end portion 29. Panel 22 may be constructed from wood, plastic, metal and the like. While not limited thereto, the width 50 of panel 22 is greater than the width 60 of ladder 100 so that panel 22 may rest atop side rails 103 of ladder 100. Moreover, panel 22 may be constructed in a variety of lengths 70.

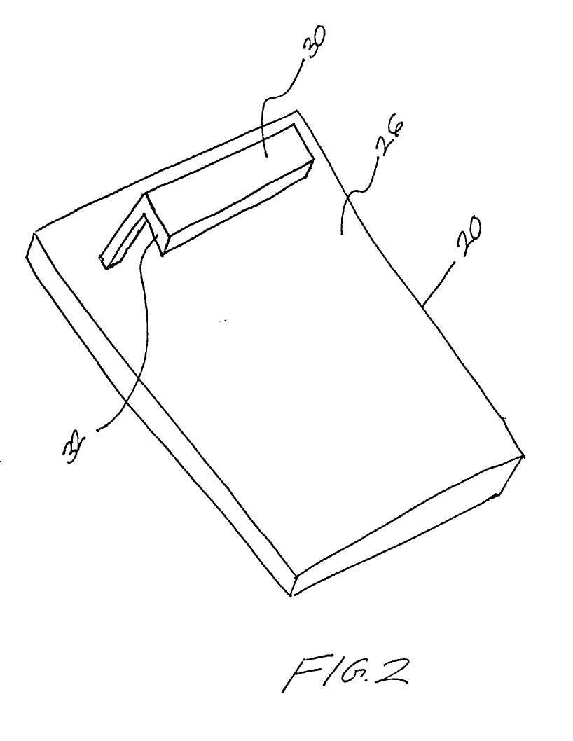

Referring to FIG. 2, attachment means 30 are affixed to bottom surface 26 of chute segment 20, and formed to removably attach to the rungs of a ladder. In the embodiment shown in FIG. 2, attachment means 30 comprises at least one hook 32 configured to grapple rung 102 of ladder 100. It is contemplated, however, that attachment means may be in any of several forms including, but not limited to, a clamp screw, velcro or magnet. In other embodiments, the attachment means may be attached to either the side surfaces or the top of panel 22, as long as the attachment means is capable of extending below at least a portion of the bottom surface so as to be capable of engaging a rung of a ladder. Of course, the attachment means may be positioned about any position of the chute segment.

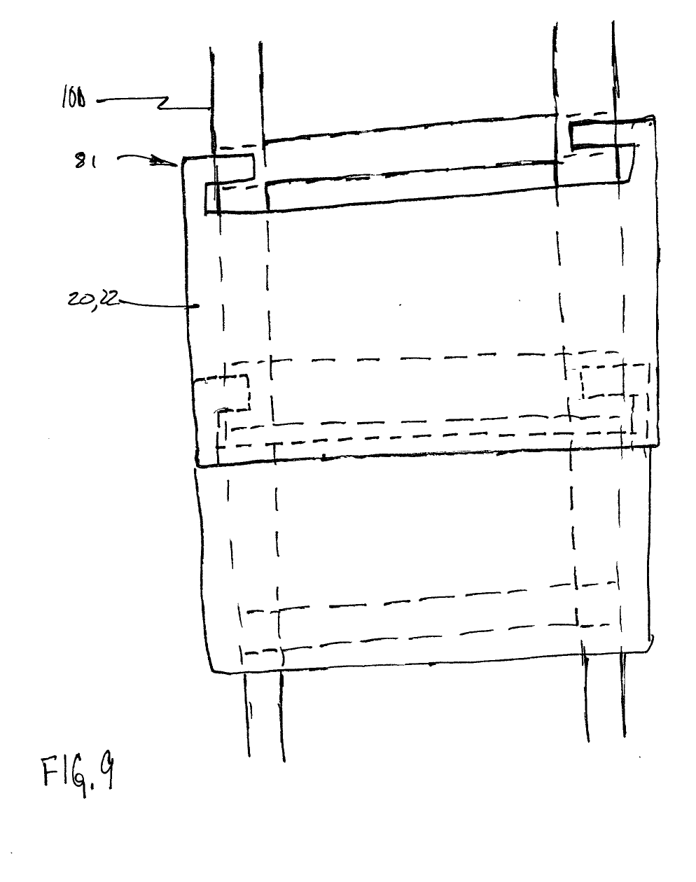

In another embodiment, as shown in FIG. 9, the attachment means may comprise a hook-type element 81 which can interface with the inner surface of a rung (hollow type rung of, for example, an extension ladder). In this manner, the outside surface of the rungs may be utilized so that the inner regions remain usable.

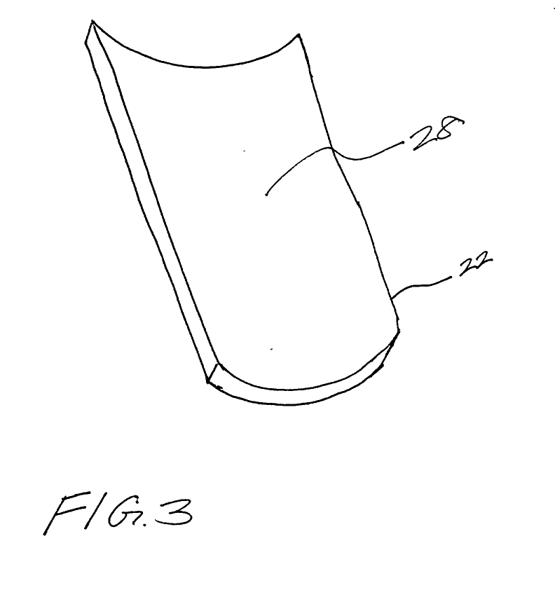

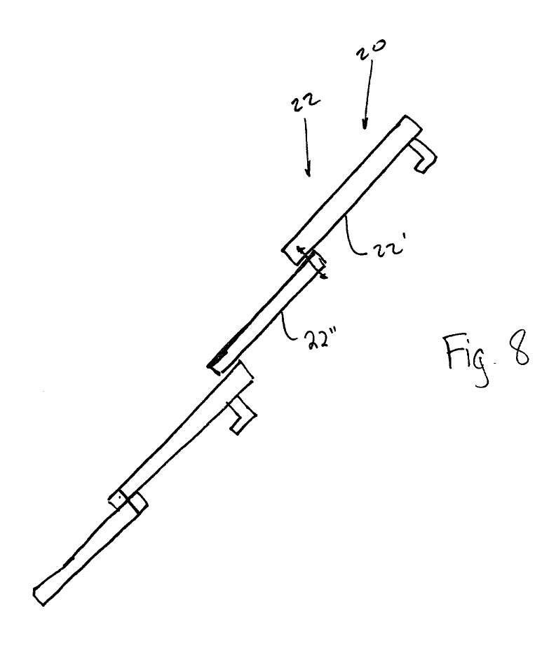

In another embodiment, shown in FIG. 3, panel 22 is concave forming channel 28. Channel 28 aids in directing material towards a refuse bin, and prevents material from falling off of panel 22. The panel may comprise a semi-circular configuration or a v-shaped configuration. In one other embodiment shown in FIG. 8, the panel 22 may comprise two separate attachable segments 22′, 22″ which can be attached to each other to such that each segment is substantially longer and fewer rungs are used to support the entire structure. Of course, while two segments are shown, a greater number of segments may be utilized. In other such embodiments, the two attachable segments may be capable of being moved relative to each other so as to alter the length of thereof.

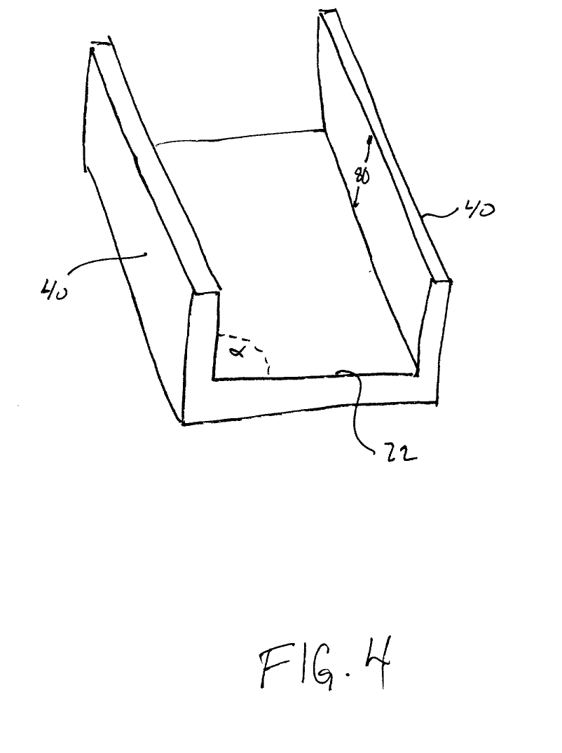

In FIG. 4, what is shown is yet another embodiment wherein panel 22 further comprises sidewalls 40. Sidewalls 40 and top surface 24 together form channel 28′ therebetween. Panel 22 and sidewalls 40 may be of unitary construction in which case they would be constructed from the same material as panel 22, or constructed so that sidewalls 40 are removably affixed to panel 22 in which case the sidewall may be constructed of different materials. Furthermore, sidewalls 40 may be constructed in a variety of heights 80.

While sidewalls 40 are shown in FIG. 4 as perpendicularly connecting to panel 22, it is contemplated that sidewalls 40 and panel 22 may also connect together at an angle a that is acute or obtuse.

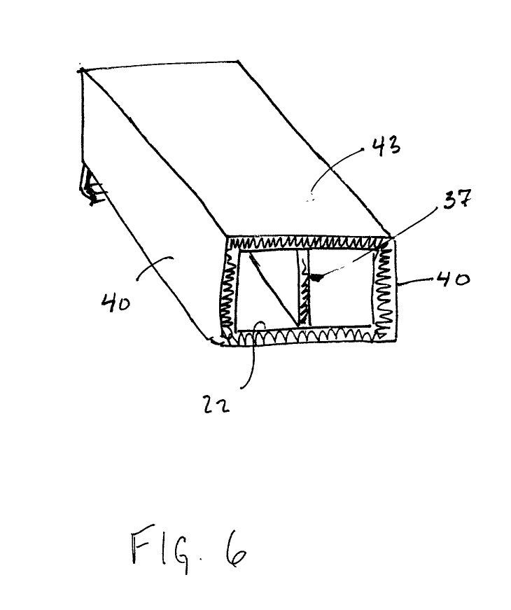

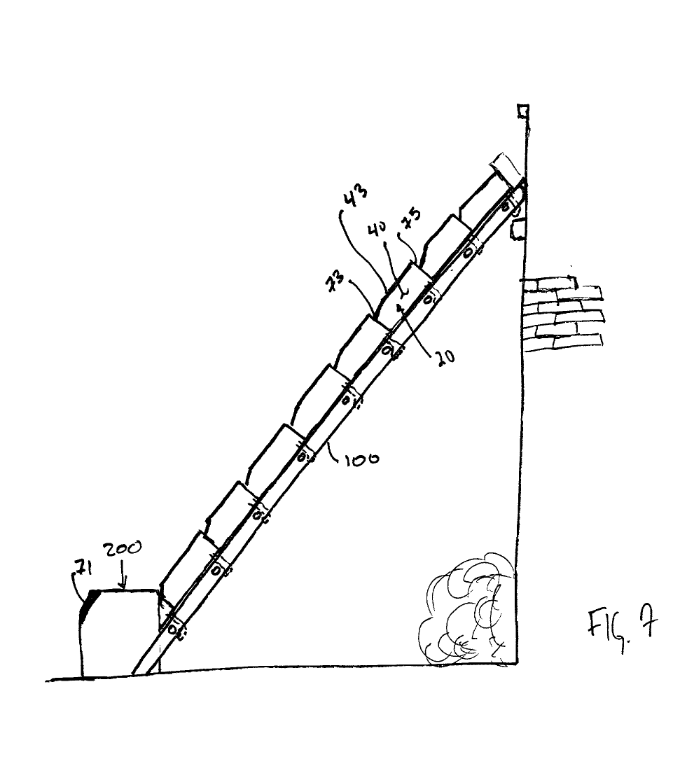

In another embodiment of the invention, as shown in FIG. 6, cover 43 may be associated with panel 22 and/or sidewalls 40. Such a cover may be removable or permanently associated with the chute. In such an embodiment, the cooperation of the cover with the panel can provide a tubular configuration in which to facilitate the passage of garbage or waste. In one embodiment, as shown in FIG. 7, the sidewalls 40 and panel 22 can be configured so that the individual segments can be nested within each other. In this manner, the passage of material therethrough can be sent systematically through a substantially fully enclosed device. Further, by placing gaskets 73, 75 at either end of the individual segments, a substantially fluid tight structure can be developed. This can be helpful in situations wherein the material being transported generates dust or particles that are unacceptable or undesirable. Moreover, the container into which the chute directs material may be sealingly attached to the chute, wherein filter 71 controls the passage of air and particles out of the system.

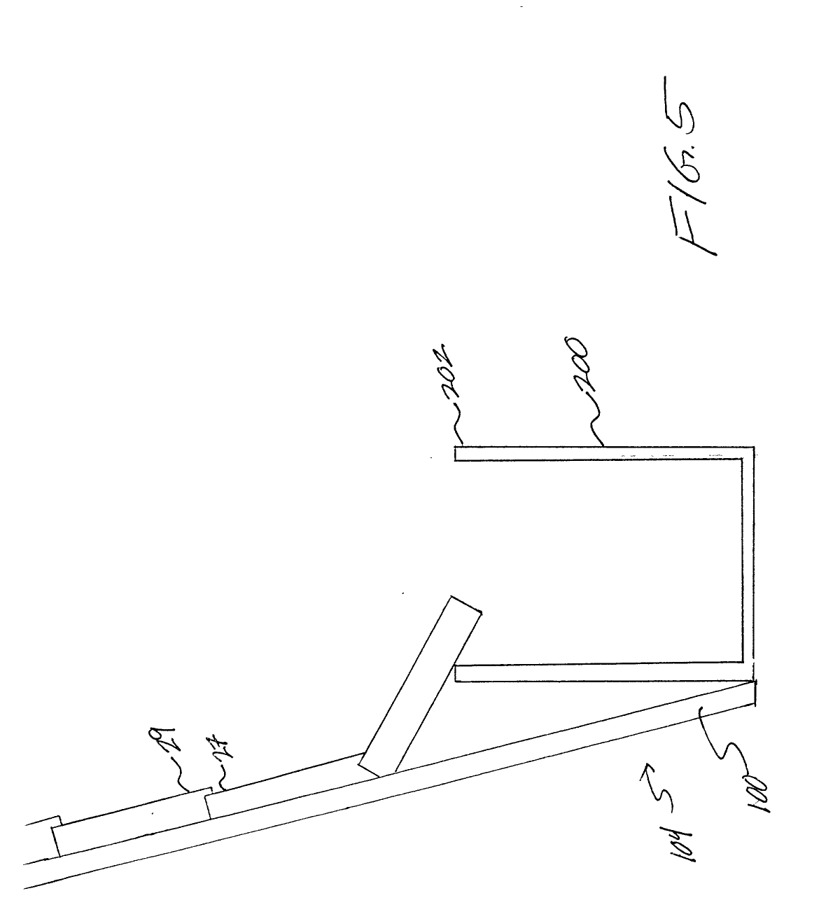

In use, ladder 100 is placed outside an opening or window of a building or home wherein construction work or renovation is taking place. The lower end portion 104 of ladder 100 may be placed adjacent to a bin or dumpster 200 as shown in FIG. 5. A first chute segment is then attached to a rung just above the rim 202 of dumpster 200. Additional chute segments are then placed on the remaining rungs in such a manner as to form a continuous chute leading from the window or opening all the way down to the bin or dumpster. The distal end portion 29 of each chute segment slightly overlays the proximal end portion 27 of the chute segment just below it. Depending on the length of each chute segment, a number of rungs may be skipped before placing the next chute segment. Finally, discarded materials are placed onto the chute. The materials slide downwardly and flow directly into the bin or dumpster below for later disposal.

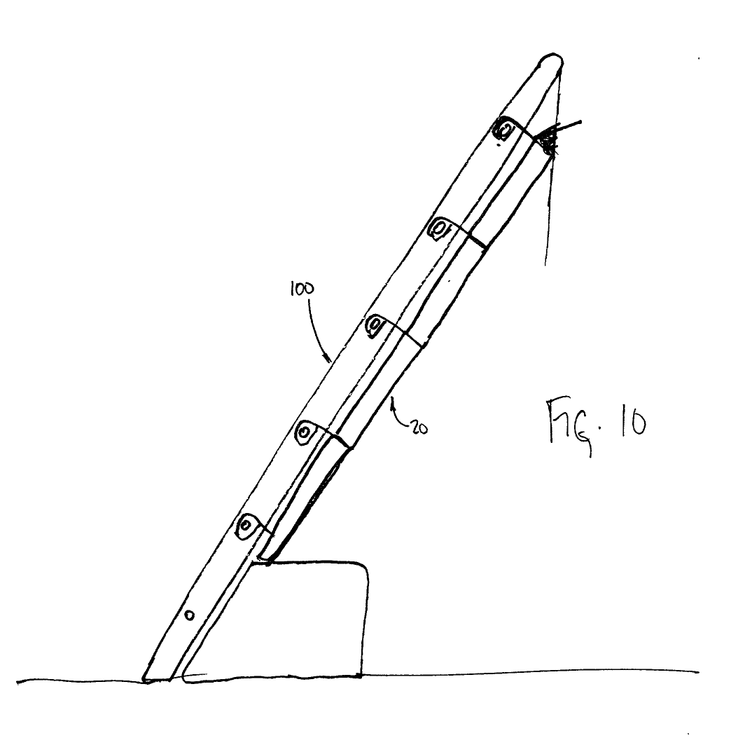

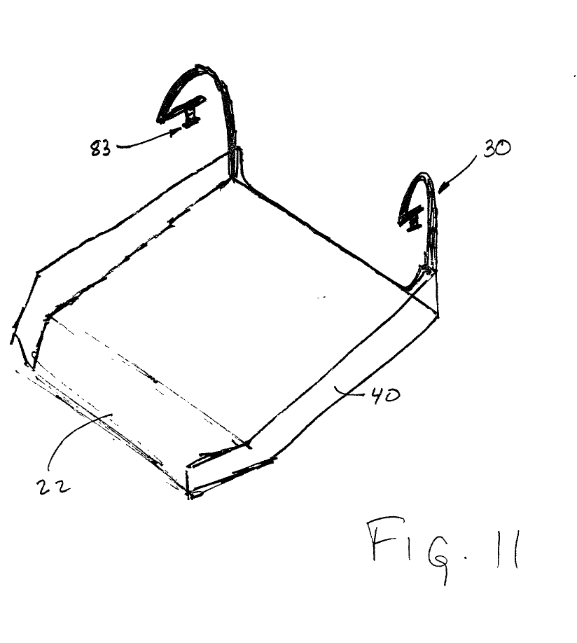

In another embodiment of the invention, as shown in FIGS. 10 and 11, the segmented chutes 20 may be attached so that they extend below the ladder. In this manner the ladder may remain simultaneously usable in association with the chute. In such an embodiment, the attachment means is positioned such that it does not interfere with the passage of debris and includes means 83 for maintaining positioning (set screw, clamp, velcro complementary shape, etc) so as to preclude the rotation about the ladder rung. The top panels and sidewalls (if utilized) are positioned so that they can nest within each other. Indeed, the nesting property itself may be utilized to preclude movement of the assembly after erection. Moreover, the individual segments may be attached to each other by way of screws, releasable adhesive, velcro, etc.

In yet another embodiment, the chute may include a divider, such as divider 37 (FIG. 6) so as to divide the chute into two separate chutes. In such an embodiment, the first chute portion may be directed to a first container, and the second chute portion may be directed to a second container. Of course it is contemplated that the chute may include any number of dividers, depending on the application.

The foregoing description and drawings merely explain and illustrate the invention and the invention is not limited thereto except insofar as the appended claims are so limited, as those skilled in the art who have the disclosure before them will be able to make modifications and variations therein without departing from the scope of the invention.

What is claimed is:

1. A ladder chute comprising:
a plurality of chute segments, each of the plurality of chute segments including:
a panel having a top surface and a bottom surface and means for attachment to a rung of a ladder, the attachment means extending from the panel and below the bottom surface of the panel to facilitate attachment to a ladder.

2. The ladder chute of claim 1 wherein at least one of the plurality of chute segments further comprises:
sidewalls extending from a proximal end to the distal end of the panel, the sidewalls cooperating with the panel to define a channel.

3. The ladder chute of claim 2 wherein at least one of the plurality of chute segments further comprises:
a top panel associated with at least one of the sidewalls, the top panel cooperating with the panel and the sidewalls to define a tunnel.

4. The ladder chute of claim 2 wherein the panel is narrower at a distal end thereof as compared to the proximal end thereof, to, in turn, facilitate nesting of the plurality of chute segments relative to each other.

5. The ladder chute of claim 1 wherein the attachment means comprises at least one hook associated with the bottom surface of the panel to faciliate attachment to a ladder.

6. The ladder chute of claim 5 wherein the attachment means is positioned proximate a proximal end of the panel.

7. The ladder chute of claim 1 wherein the top panel comprises an upwardly concave shape.

8. The ladder chute of claim 1 wherein the upwardly concave shape comprises one of the group consisting of: a v-shaped configuration and a semicircular configuration.

9. The ladder chute of claim 1 wherein at least one of the plurality of chute segments further comprises a top panel, to, in turn, define a tubular configuration.

10. The ladder chute of claim 1 wherein at least one of the chute segments further includes at least one divider.

11. The ladder chute of claim 1 wherein the attachment means comprises a member configured to interface with at least a portion of an interior region of an at least partially hollow ladder rung.

12. The ladder chute of claim 1 wherein the plurality of segmented chutes is greater than five segmented chutes.

13. The ladder chute of claim 1 wherein the plurality of segmented chutes includes at least two segmented chutes of different length.

14. The ladder chute of claim 1 wherein the length thereof is adjustable.

15. A ladder chute comprising:
a plurality of chute segments, each of the plurality of chute segments including:
a panel having a top surface and a bottom surface and means for attachment to a rung of a ladder, the attachment means extending from the panel and above the upper surface of the panel to facilitate attachment to a ladder substantially without affecting the use thereof by a user.

16. The ladder chute of claim 15 wherein the attachment means comprises at least one hook positioned at either side of the panel, at least one of the hooks being configured so as to include means for precluding rotative movement of the panel relative to a ladder rung to which the panel is associated.

17. A method of erecting a ladder chute comprising the steps of:
providing a plurality of chute segments;
providing a ladder having a plurality of rungs;
attaching a first chute segment to a first rung;
attaching at least one subsequent chute segment a second rung; and
overlaying at least a portion of the subsequent chute segment over the first chute segment.

18. The method according to claim 17 further comprising the step of associating a container with at least one chute segment, to in turn, facilitate the slidable movement of debris from the plurality of chute segments into the container.
